(19) United States
(12) Patent Application Publication
(10) Pub. No.: US 2004/0263667 A1
(43) Pub. Date: Dec. 30, 2004

(54) Solid-state imaging apparatus and method for making the same

(76) Inventors: Kwan-Jai Lee, Yongin-si (KR); Sa-Yoon Kang, Seoul (KR); Seung-Kon Mok, Suwon-si (KR)

Correspondence Address: HARNESS, DICKEY & PIERCE, P.L.C., P.O. BOX 8910, RESTON, VA, 20195, US

(21) Appl. No.: 10/843,483

(22) Filed: May 12, 2004

(30) Foreign Application Priority Data
Jun. 18, 2003 (KR) 2003-39523

(51) Int. Cl. H04N 5/225

(52) U.S. Cl. 348/340

(57) ABSTRACT

PURPOSE: A semiconductor package and a method for fabricating the same are provided to shorten a length of a signal line for connecting a semiconductor chip with a substrate and simplify a structure of the semiconductor package.

CONSTITUTION: A semiconductor package is formed with the first chip(110), a substrate(130), a connection portion(150), and a glass(170). The first chip(110) is installed on the substrate(130). The connection portion(150) is used for connecting the first chip(110) with the substrate(130). The glass(170) is formed on an upper surface of the first chip(110). A via hole(115) penetrates each bonding pad portion(113) around the first chip(110). A connection metal(140) is formed on an inside of the via hole(115). A via hole(135) is formed in the substrate(130). The connection metal(140) is formed on an inside of the via hole(135). The first chip(110) is electrically connected with a bottom face of the substrate(130) by the connection metal(140) of the via holes(115,135). A projection portion(131) is formed around the substrate(130). The glass(170) is combined with the projection portion(131) and the first chip(110) by applying an adhesive(160) on the bonding pad portion(113). A land portion(180) is formed on the bottom face of the substrate(130) by extending the connection metal(140) of the via hole(135).

### CROSS REFERENCE TO RELATED APPLICATION

This application claims the priority of Korean Patent Application No. 10-2003-0039523 filed on Jun. 18, 2003, in the Korean Intellectual Property Office, the disclosure of which is incorporated herein by reference.

### BACKGROUND OF THE INVENTION

1. Field of the Invention

The present invention relates to a solid-state imaging apparatus, and more particularly, a solid-state imaging chip that converts light into an image signal, the solid-state imaging chip including first terminals on a top surface of the solid-state imaging chip and second terminals on a bottom surface of the solid-state imaging chip.

2. Description of the Related Art

Mobile equipment, such as portable terminals or mobile phones, typically may include a built-in camera module in which a solid-state imaging chip and lens may be incorporated. In such a camera equipped mobile phone, an image of a calling party may be captured by the camera and provided as input to the mobile phone as image data. The input image data may then be transmitted to a called party.

The demand for miniaturized camera modules used in such mobile equipment may have increased as mobile phones or portable personal computers have become smaller and smaller, Semiconductor packages may be being developed that may include a lens and a solid-state imaging chip to help meet the demand for miniaturized camera modules.

FIGS. 11 and 12 are schematic diagrams of conventional solid-state imaging apparatuses. Referring to FIG. 11, which shows a schematic of a camera module, a lens mounting portion 15, to which a solid-state imaging lens 20 and an IR cut filter 25 may be attached, may be fixed to the top surface of a printed circuit board (PCB) 10 with an adhesive. A solid-state imaging chip 40 may include photoelectric conversion elements for converting light from the solid-state imaging lens 20 into an image signal. The solid-state imaging chip 40 may be centrally placed on the top surface of the PCB 10 and may be connected to the PCB 10 by bonding wires 2.

In the solid-state imaging apparatus shown in FIG. 11, the solid-state imaging chip 40 may be mounted on and connected to the PCB 10 by the bonding wires 2. Thus, pads for the bonding wires 2 may be arranged around the solid-state imaging chip 40 and on the PCB 10, which may impede miniaturization of a semiconductor package.

FIG. 12 shows another conventional camera module, in which a lens mounting portion 15, to which a solid-state imaging lens 20 and an IR cut filter 25 may be attached, may be fixed on the top surface of a PCB 6 with an adhesive. The PCB 6 may have a cavity formed on a portion thereof or may be formed of a transparent material. A solid-state imaging chip 40 may include photoelectric conversion elements for converting light from the solid-state imaging lens 20 into an image signal. The solid-state imaging chip 40 may be placed on the center of the bottom surface of the PCB 6 and may be bonded to the PCB 6 using flip chip bonds 4.

In the above case shown in FIG. 12, where the solid-state imaging chip 40 may be connected to the bottom portion of the PCB 6 by the flip chip bonds 4, the mounting area may be relatively small compared to the case where the solid-state imaging chip 40 may be connected to the upper portion of the PCB 6 by the wire bonds 2 shown in FIG. 11. This structure may have several limitations including a necessity to form a separate cavity on the PCB 6, or to form the PCB 6 from a transparent material.

### SUMMARY OF THE INVENTION

According to an example embodiment of the invention, a solid-state imaging apparatus comprising a lens mounting portion to which a solid-state imaging lens is attached and a solid-state imaging chip installed below the solid-state imaging lens, for converting light from the solid-state imaging lens into an image signal. The solid state imaging apparatus also includes a conductive material deposited in via holes formed in scribe lines on the solid-state imaging chip, the conductive material for electrically connecting bonding pads formed on a top surface of the solid-state imaging chip to the terminals formed on the bottom surface of the solid-state imaging chip. Furthermore, the solid-state imaging apparatus includes a board attached to the lens mounting portion and electrically connected to the solid-state imaging chip by the terminals formed on the bottom surface of the solid-state imaging chip.

In another example embodiment of the invention, a solid-state imaging apparatus includes a lens mounting portion to which a solid-state imaging lens is attached and a solid-state imaging chip installed below the solid-state imaging lens, for converting light from the solid-state imaging lens into an image signal. The solid-state imaging apparatus also includes conductive lines formed at least on a lateral side of the solid-state imaging chip, the conductive lines for electrically connecting bonding pads formed on the top surface of the solid-state imaging chip to the terminals formed on the bottom surface of the solid-state imaging chip; and a board fixed to the bottom surface of the lens mounting portion and electrically connected to the solid-state imaging chip by the conductive lines formed on the bottom surface of the solid-state imaging chip.

In another example embodiment of the invention, a solid-state imaging apparatus includes a solid-state imaging chip that converts light into an image signal, the solid-state imaging chip including first terminals on a top surface of the solid-state imaging chip and second terminals on a bottom surface of the solid-state imaging chip.

In another example embodiment of the invention, a solid-state imaging apparatus includes a lens mounting portion to which a solid-state imaging lens is attached; and a solid-state imaging chip that converts light into an image signal, the solid-state imaging chip including first terminals on a top surface of the solid-state imaging chip and second terminals on a bottom surface of the solid-state imaging chip. The solid-state imaging apparatus additionally includes conductive material deposited in holes formed in scribe lines on the solid-state imaging chip, the conductive material for electrically connecting at least a portion of the first terminals to at least a portion of the second terminals; and a board attached to the lens mounting portion and electrically connected to the solid-state imaging chip by the second terminals.

In another example embodiment of the invention, a solid-state imaging apparatus includes a lens mounting portion to which a solid-state imaging lens is attached and a solid-state imaging chip that converts light into an image signal, the solid-state imaging chip including first terminals on a top surface of the solid-state imaging chip and second terminals on a bottom surface of the solid-state imaging chip. The solid-state imaging apparatus further includes conductive lines for electrically connecting at least a portion of the first terminals to at least a portion of the second terminals and a board fixed to the bottom surface of the lens mounting portion and electrically connected to the solid-state imaging chip by the conductive lines formed on the bottom surface of the solid-state imaging chip.

In another example embodiment of the invention, a method of making a solid-state imaging apparatus includes forming first terminals on a top surface of a solid-state imaging chip that converts light into an image signal; and forming second terminals on a bottom surface of the solid-state imaging chip.

Other features and advantages of other example embodiments of the invention are incorporated into the following more detailed description and the accompanying drawings.

### BRIEF DESCRIPTION OF THE DRAWINGS

Example embodiments of the invention will become more apparent by describing them with reference to the attached drawings.

FIGS. 1A through 10 are schematic diagrams of solid-state imaging apparatuses according to example embodiments of the invention.

FIGS. 11 and 12 are schematic diagrams of conventional solid-state imaging apparatuses.

### DETAILED DESCRIPTION OF EXAMPLE EMBODIMENTS OF THE INVENTION

The present invention is now described with reference to the accompanying drawings in which example embodiments of the invention are shown. The present invention may, however, be embodied in many different forms and should not be construed as being limited to the example embodiments set forth herein. Rather, these example embodiments are provided so that this disclosure will be thorough and complete, and will convey the scope of various example embodiments of the invention to those skilled in the art.

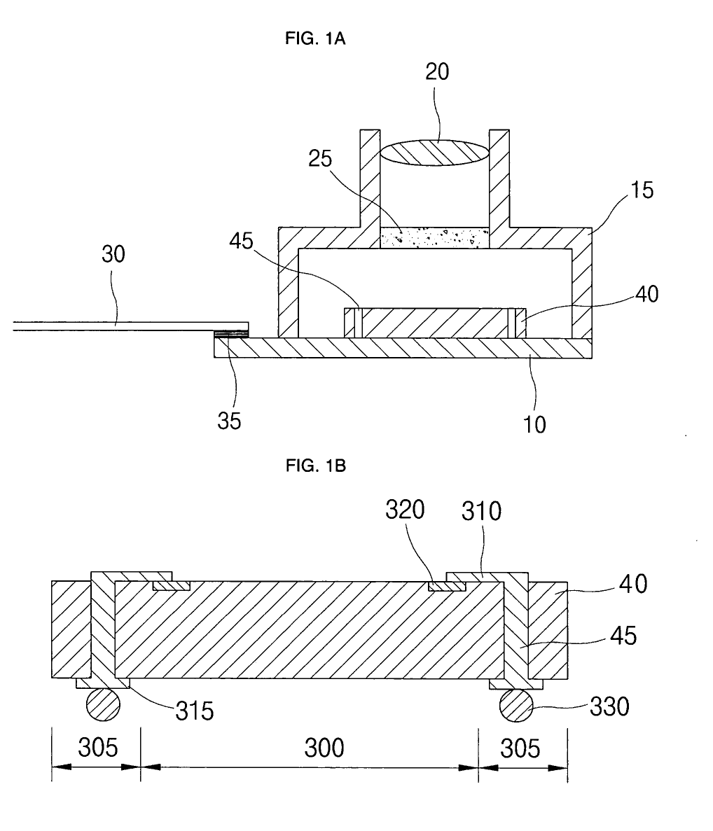

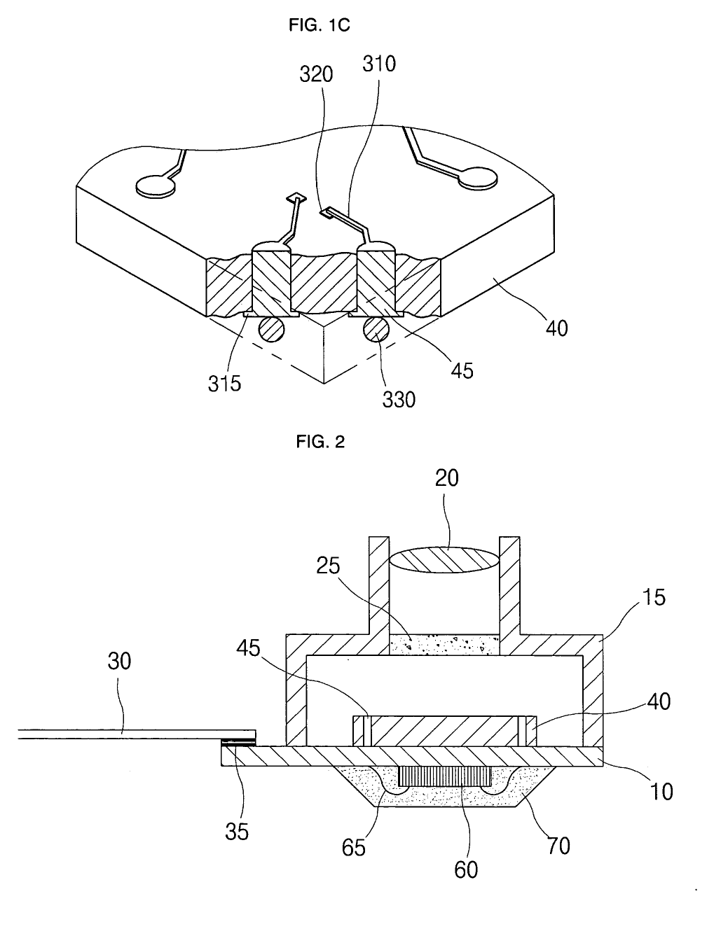

An example embodiment of the invention is now described with reference to FIG. 1A through FIG. 1C.

As shown in an example embodiment of the invention as shown in FIG. 1A, a lens mounting portion 15, to which a solid-state imaging lens 20 and an IR cut filter 25 may be attached, may be connected to the top surface of a board 10, for example, a printed circuit board (PCB) with an adhesive. A solid-state imaging chip 40 may include photoelectric conversion elements for converting light from the solid-state imaging lens 20 into an image signal, and may be connected to the top surface of the BOARD 10 with an adhesive.

The solid-state imaging chip 40 may include a photoelectric conversion unit (i.e., a sensor unit), a driving circuit, an analog-to-digital (A/D) converting unit, a signal processing unit, and/or a semiconductor circuit. The photoelectric conversion unit may have photoelectric conversion elements arranged in a two-dimensional matrix, forming a CMOS image sensor (CIS). The driving circuit unit may sequentially drive the photoelectric conversion elements to obtain signal charges. The A/D converting unit may convert the signal charges into digital signals. The signal processing unit processes the digital signals to output image signals. The semiconductor circuit may have an exposure controller formed on the same semiconductor chip; the exposure controller may electrically control the exposure time based on the output level of the digital signal. The solid-state imaging chip 40 may include a charged coupled device (CCD).

FIG. 1B is an enlarged cross-sectional view of the solid-state imaging chip 40 shown in FIG. 1A in accordance with an example embodiment of the invention.

FIG. 1C is an exploded perspective view illustrating an enlarged portion of the solid-state imaging chip 40 shown in FIG. 1A in accordance with an example embodiment of the invention.

As shown in FIGS. 1A through 1C, according to an example embodiment of the invention, the solid-state imaging chip 40 may include an active region 300 and scribe lines 305. Via holes 45 may be formed in the scribe lines 305 by etching or using laser. The via holes 45 may be connected to bonding pads/terminals 320 formed on the top surface of the solid-state imaging chip 40 by electrical wiring 310. The bonding pads/terminals 320 formed on the solid-state imaging chip 40 may be electrically connected to terminals 315 that may be formed on the bottom surface of the solid-state imaging chip 40 by a conductive material deposited in the via holes 45. Al, Ag, Au or Ni may be preferably used as the conductive material. However, other conductive materials including composite conducting materials may also be used. The conductive material may be deposited by different methods including sputtering, chemical vapor deposition (CVD), electroplating, or a combination thereof, Bottom portions of the via holes 45 may be connected to the board 10 by electrical connectors 330, such as solder balls, metal bumps or conductive particles contained in an anisotropic conductive film (ACF).

Techniques of forming the via holes 45 and connecting the via holes 45 with the board 10 are disclosed in U.S. Pat. No. 6,235,554 and Korean Patent Published Application No. 2003-0023040, respectively.

The board 10 and a flexible cable 30 may be electrically connected to each other by a wiring connector 35.

The above-described solid-state imaging apparatus according to an example embodiment of the invention shown in FIG. 1A operates as follows. An image of an object is formed on a sensor of the solid-state imaging chip 40 mounted on the board 10 through the solid-state imaging lens 20 and the IR cut filter 25, and may be photoelectrically converted and output as an image signal in either digital or analog form.

Another example embodiment of the invention will now be described with reference to FIG. 2. FIG. 2 is a schematic diagram showing the construction of a solid-state imaging apparatus according to an example embodiment of invention, in which elements corresponding to those shown in FIG. 1A are denoted by the similar reference numerals.

The solid-state imaging apparatus shown in FIG. 2 is different than the solid-state imaging apparatus shown in FIG. 1A in that the solid-state imaging apparatus further may include an image signal processing semiconductor chip 60 electrically connected to a terminal (not shown) on the bottom surface of the board 10 by bonding wires 65. The image signal processing semiconductor chip 60 processes the image signal output from the solid-state imaging chip 40.

In the illustrative example embodiment shown in FIG. 2, the image signal processing semiconductor chip 60 may be encapsulated using an insulating encapsulation resin 70 by transfer molding. As a result, the reliability of the bonded portion by the bonding wires 65 may be improved and the strength thereof may also be reinforced. Examples of the insulating encapsulation resin 70 may include epoxy resin, silicon resin, and the like.

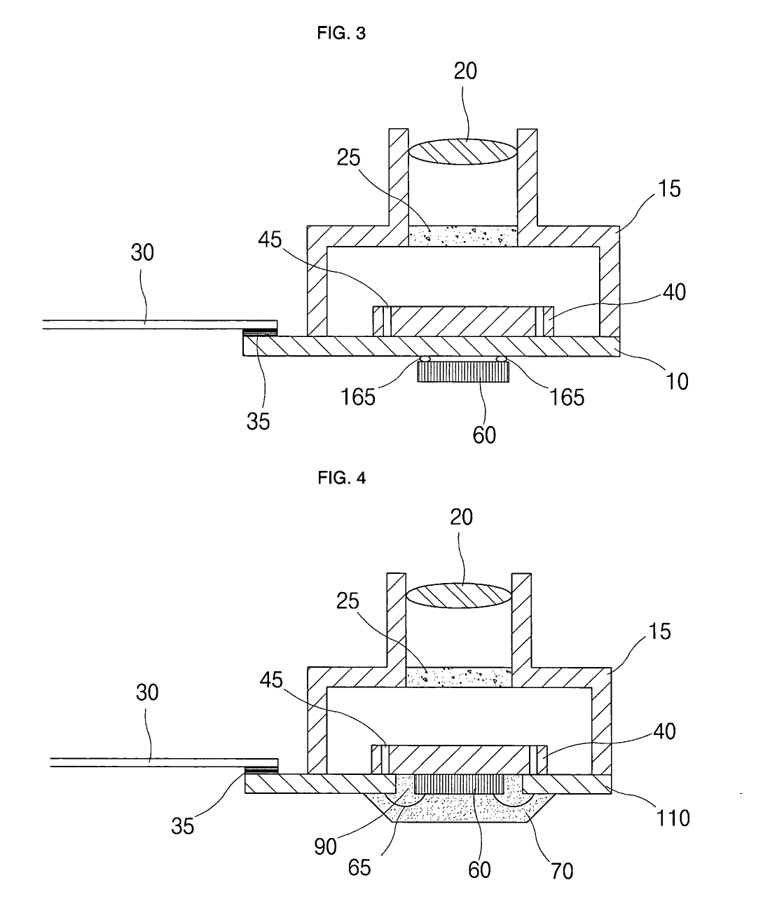

Another example embodiment of the invention is now described with reference to FIG. 3. FIG. 3 is a schematic diagram showing the construction of a solid-state imaging apparatus according to an example embodiment of the invention, in which elements corresponding to those shown in FIG. 1A are denoted by the similar reference numerals.

The solid-state imaging apparatus shown in FIG. 3 is different from the solid-state imaging apparatus shown in FIG. 1A in that an image signal processing semiconductor chip 60 may be electrically connected to wirings formed on the bottom surface of the board 10 by electrical connectors 165, including and not limited to metal bumps, solder balls, conductive particles, other like connectors, or combinations thereof, contained in an anisotropic conductive film (ACF). The reliability of the electrical connectors 165 may be enhanced and the strength thereof may be reinforced by encapsulating the electrical connectors 165 using an insulating encapsulation resin (not shown), such as epoxy resin, silicon resin, or the like.

In the solid-state imaging apparatus according to the illustrative example embodiment shown in FIG. 3, the electrical connectors 165, such as metal bumps or solder balls, may be used to connect the image signal processing semiconductor chip 60, instead of the bonding wires, thereby making the image signal processing semiconductor chip 60 thinner.

Another example embodiment of the invention is now described with reference to FIG. 4. FIG. 4 is a schematic diagram showing the construction of a solid-state imaging apparatus according to an example embodiment of the invention, in which elements corresponding to those shown in FIG. 2 are denoted by the similar reference numerals.

The solid-state imaging apparatus shown in FIG. 4 is different from solid-state imaging apparatus shown in FIG. 2 in that a cavity 90 may be formed on a portion of the board 110 (for example, a PCB board) facing the solid-state imaging lens 20, the solid-state imaging chip 40 may be formed in the cavity 90, and the image signal processing semiconductor chip 60 may be connected to the bottom surface of the solid-state imaging chip 40 in the cavity 90 of the board 110 and may be bonded to a terminal (not shown) formed at the bottom surface of the board 110 by bonding wires 65.

In the solid-state imaging apparatus according to the example embodiment of FIG. 4, the image signal processing semiconductor chip 60 may be disposed in the cavity 90 of the board 110 and may be fixed to the bottom surface of the solid-state imaging chip 40 with an adhesive. As a result, the solid-state imaging semiconductor package may be made thinner by saving space up to the thickness of the board 110.

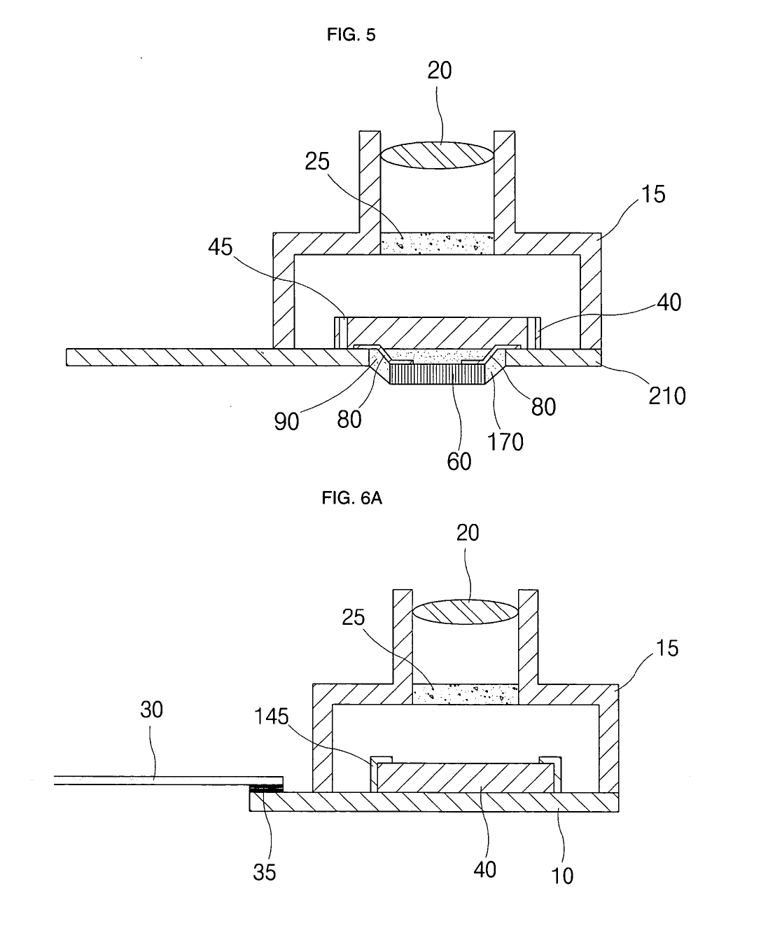

Another example embodiment of the invention is now described with reference to FIG. 5. FIG. 5 is a schematic diagram showing the construction of a solid-state imaging apparatus according to an example embodiment of the invention, in which elements corresponding to those shown in FIG. 1A are denoted by the similar reference numerals.

The solid-state imaging apparatus shown in FIG. 5 is different from the solid-state imaging apparatus shown in FIG. 1A in that the board 210 (e.g., a flexible PCB) has a cavity 90 formed on a portion facing the solid-state imaging lens 20, and the image signal processing semiconductor chip 60 formed in the cavity 90 may be bonded to a lead 80 (e.g., a copper lead) on the board 210. Tape automated bonding (TAB) may be used for the bond.

In the example embodiment shown in FIG. 5, the image signal processing semiconductor chip 60 may be encapsulated by an insulating encapsulation resin 170. As a result, the reliability of the bonded portion by TAB may be improved and the strength thereof may also be reinforced. The insulating encapsulation resin 170 may be a liquid, thermally curable resin.

Another example embodiment of the invention is now described with reference to FIG. 6A through FIG. 6C. FIG. 6A is a schematic diagram showing the construction of a solid-state imaging apparatus according to an example embodiment of the invention. FIG. 6B is an enlarged cross-sectional view of the solid-state imaging chip 40 shown in FIG. 6A according to an example embodiment of the invention, and FIG. 6C is an exploded perspective view of the enlarged portion of the solid-state imaging chip 40 shown in FIG. 6A according to an example embodiment of the invention.

As shown in FIGS. 6A through 6C, via holes may be formed in scribe lines on the solid-state imaging chip 40 by etching or by using a laser, and a conductive material may be deposited in the via holes. Then, the via holes may be cut to form conductive lines 145.

In FIG. 6A through FIG. 6C, elements corresponding to those shown in FIG. 1A are denoted by the similar reference numerals

The solid-state imaging apparatus shown in FIG. 6A is different from the solid-state imaging apparatus shown in FIG. 1A in that the solid-state imaging chip 40 and the board 10 may be electrically connected to each other by the conductive lines 145, formed at lateral sides of the solid-state imaging chip 40. The conductive lines 145 may be made from a conductive metal including Al, Ag, Au, Ni, like materials, or a combination thereof, in order for them to be electrically conductive. Deposition of the conductive material may be performed by sputtering, chemical vapor deposition (CVD) or electroplating.

The via holes may be formed in the scribe lines of a wafer by a method including lasing, etching, grinding, or other like ways to scribe a line. Also, the conductive lines 145 may be electrically connected to bonding pads/terminals 320 formed on the surface of the solid-state imaging chip 40 by electrical wires 410. The conductive lines 145 electrically connect the bonding pads/terminals 320 and terminals 415 formed on the lower surface of the solid-state imaging chip 40. Also, bottom portions of the conductive lines 145 may be connected to the board 10 by electrical connectors 330, such as solder balls, metal bumps or conductive particles contained in an anisotropic conductive film (ACF).

As in the example embodiment shown in FIG. 1A, the bonding wires 2 need not be employed, to help achieve the miniaturization of the semiconductor package.

Example techniques of forming the via holes 145 and connecting the via holes 145 to the board 10 are disclosed in U.S. Pat. No. 6,391,685 and Korean Patent Published Application No. 2001-0011159, respectively.

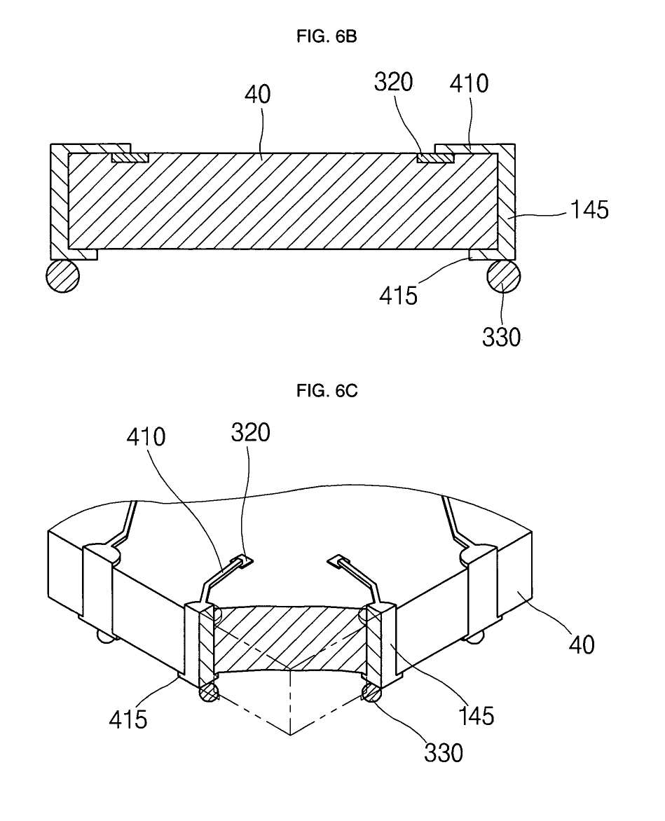

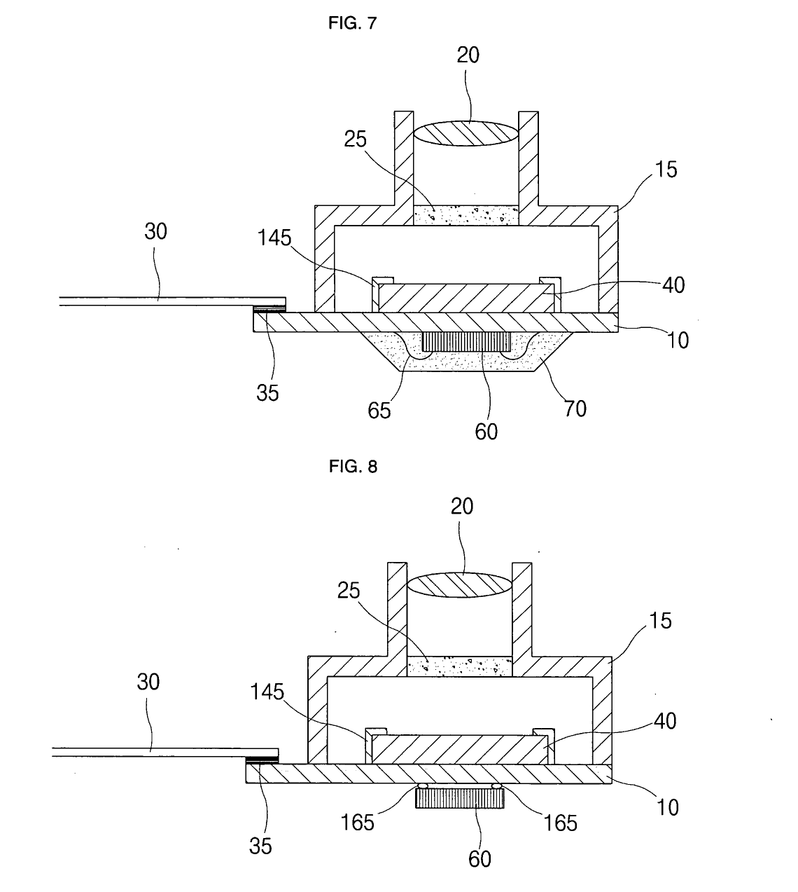

Another embodiment of the invention is now described with reference to FIG. 7. FIG. 7 is a schematic diagram showing the construction of a solid-state imaging apparatus according to an example embodiment of the invention, in which elements corresponding to those shown in FIG. 6A are denoted by the similar reference numerals.

The solid-state imaging apparatus shown in FIG. 7 is different from the solid-state imaging apparatus shown in FIG. 6A in that it further may include an image signal processing semiconductor chip 60 connected to the bottom surface of the board 10 by a bonding wire 65, for processing the image signal that may be output from the solid-state imaging chip 40.

In the example embodiment of FIG. 7, the image signal processing semiconductor chip 60 may be encapsulated with an insulating encapsulation resin 70 by a molding, such as transfer molding, so that the reliability of a bonded portion of the bonding wire 65 may be enhanced and/or the strength thereof may be reinforced. Examples of the insulating encapsulation resin 70 may include an epoxy resin, a silicon resin and the like.

In the solid-state imaging apparatus shown in FIG. 7, the image signal processing semiconductor chip 60 may be incorporated into the solid-state imaging semiconductor package, and as a result the solid-state imaging semiconductor package may be made smaller and/or thinner.

Another embodiment of the invention is now described with reference to FIG. 8. FIG. 8 is a schematic diagram showing the construction of a solid-state imaging apparatus according to an example embodiment of the invention, in which elements corresponding to those shown in FIG. 6A are denoted by the similar reference numerals.

The solid-state imaging apparatus shown in FIG. 8 is different from the solid-state imaging apparatus shown in FIG. 6A in that it further may include an image signal processing semiconductor chip 60 at the bottom portion of the board 10 and the image signal processing semiconductor chip 60 may be electrically connected to a terminal formed on the bottom portion of the board 10 by electrical connectors 165.

Examples of the electrical connectors 165 may include metal bumps, solder balls or conductive particles contained in an anisotropic conductive film (ACF), and the like. As in the above-described example embodiments, the electrical connectors 165 may be encapsulated using an insulating encapsulation resin (not shown), which may enhance the reliability of the electrically connected portion and/or may reinforce the strength thereof. Examples of the insulating encapsulation resin (not shown) may include an epoxy resin, a silicon resin and the like. The electrical connections of the image signal processing semiconductor chip 60 may be accomplished by the electrical connectors 165 which may include metal bumps or solder balls, rather than by bonding wires. The use of metal bumps or solder balls may allow further miniaturization of the solid-state imaging apparatus.

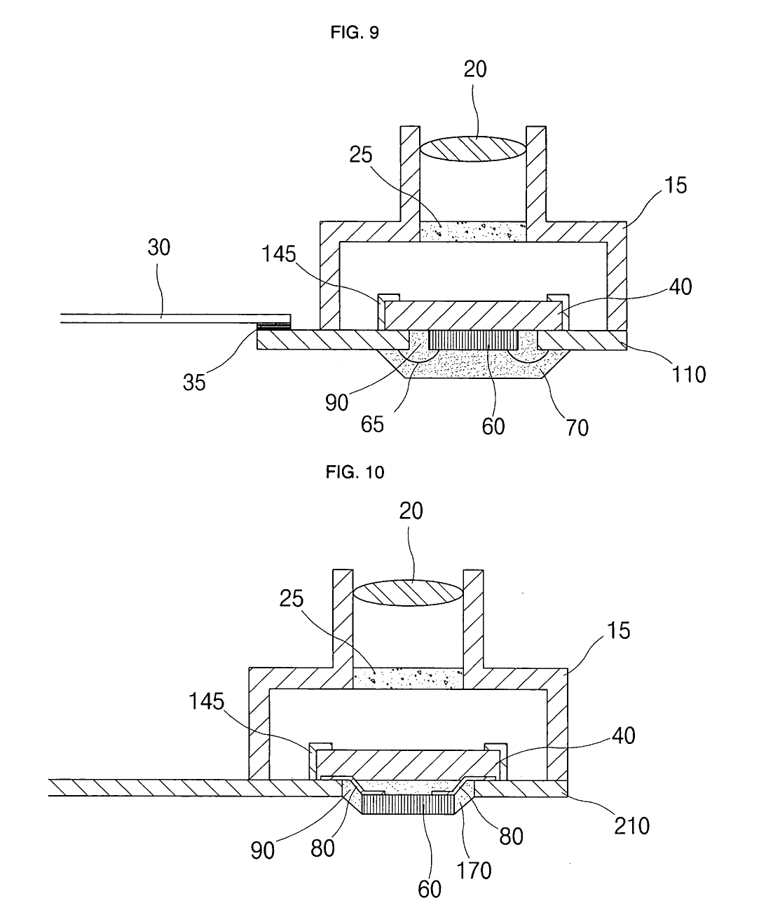

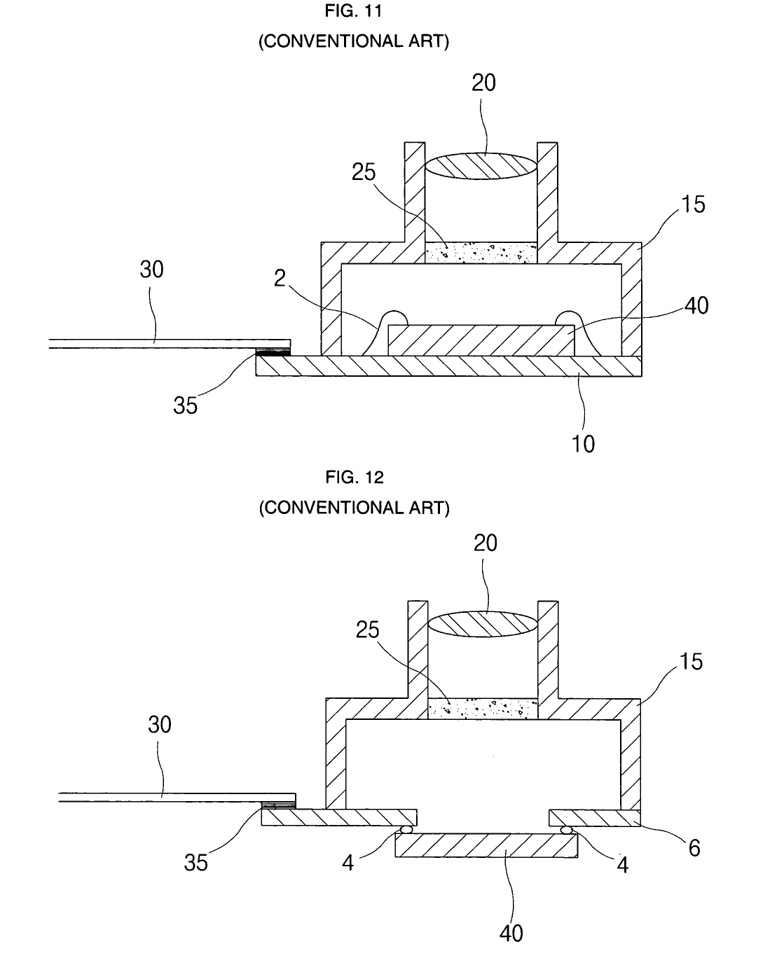

Next, another example embodiment of the invention is described with reference to FIG. 9. FIG. 9 is a schematic diagram showing the construction of a solid-state imaging apparatus according to an example embodiment of the invention, in which elements corresponding to those shown in FIG. 7 are denoted by similar reference numerals.

The solid-state imaging apparatus shown in FIG. 9 is different from the solid-state imaging apparatus shown in FIG. 7 in that a cavity 90 may be formed on a portion of the board 110 facing the solid-state imaging lens 20, the solid-state imaging chip 40 may be formed in the cavity 90, and the image signal processing semiconductor chip 60 may be bonded to the bottom surface of the solid-state imaging chip 40 in the cavity 90 of the board 110 and may be electrically connected to a terminal formed on the bottom portion of the board 110 by a bonding wire 65.

In the solid-state imaging apparatus shown in FIG. 9, the image signal processing semiconductor chip 60 may be disposed within the cavity 90 of the board 110 and may be adhered to the bottom portion of the solid-state imaging chip 40 with an adhesive. The inclusion of the signal processing semiconductor chip 60 within the cavity 90 may enable the solid-state imaging semiconductor package to be made thinner.

Another example embodiment of the invention is now described with reference to FIG. 10. FIG. 10 is a schematic diagram showing the construction of a solid-state imaging apparatus according to an example embodiment of the invention, in which elements corresponding to those shown in FIG. 6A are denoted by similar reference numerals.

The solid-state imaging apparatus shown in FIG. 10 may be different from the solid-state imaging apparatus shown in FIG. 6A in that a flexible board 210 may be used, in which a cavity 90 may be formed in a portion facing the solid-state imaging lens 20, and the image signal processing semiconductor chip 60 disposed within the cavity may be bonded to a lead 80 (e.g., a copper lead) on the board 210. The bonding may be accomplished using tape automated bonding (TAB).

In the example embodiment of FIG. 10, the image signal processing semiconductor chip 60 may be encapsulated by an insulating encapsulation resin 170. The reliability of the portion bonded may be enhanced and the strength thereof may be reinforced using a bonding method, such as TAB. The insulating encapsulation resin 170 may be in a liquid state and may be a thermally curable resin.

As described above, in a solid-state imaging apparatus according to an example embodiment of the invention, a solid-state imaging chip and a board may be connected in such a way that the solid-state imaging apparatus may be made thinner and with a relatively smaller mounting area than a conventional imaging apparatus.

While the present invention may have been particularly shown and described with respect to example embodiments thereof, it will be understood by those skilled in the art that the foregoing and other changes in form and details may be made therein without departing from the spirit and scope of the invention which should be limited only by the scope of the appended claims. Thus, preferred embodiments of the invention disclosed above may be used in a generic and descriptive sense only and not for purposes of limitation.

What is claimed is:

1. A solid-state imaging apparatus comprising:
a lens mounting portion to which a solid-state imaging lens is attached;
a solid-state imaging chip installed below the solid-state imaging lens, for converting light from the solid-state imaging lens into an image signal;
a conductive material deposited in via holes formed in scribe lines on the solid-state imaging chip, the conductive material for electrically connecting bonding pads formed on a top surface of the solid-state imaging chip to the terminals formed on the bottom surface of the solid-state imaging chip; and
a board attached to the lens mounting portion and electrically connected to the solid-state imaging chip by the terminals formed on the bottom surface of the solid-state imaging chip.

2. The solid-state imaging apparatus of claim 1, wherein the terminals formed on the bottom surface of the solid-state imaging chip are connected to metal wirings formed on the top surface of the board by solder balls or metal bumps.

3. The solid-state imaging apparatus of claim 1, further comprising an image signal processing semiconductor chip that is electrically connected to terminals formed on the bottom surface of the board.

4. The solid-state imaging apparatus of claim 3, wherein the image signal processing semiconductor chip is electrically connected to terminals formed on the bottom surface of the board by bonding wires.

5. The solid-state imaging apparatus of claim 3, wherein the image signal processing semiconductor chip is electrically connected to terminals formed on the bottom surface of the board by solder balls or metal bumps.

6. The solid-state imaging apparatus of claim 3, wherein the board has a cavity formed below the solid-state imaging lens, and the image signal processing semiconductor chip is adhered to the bottom surface of the solid-state imaging chip in the cavity.

7. The solid-state imaging apparatus of claim 6, wherein the image signal processing semiconductor chip is electrically connected to terminals formed on the bottom surface of the board by bonding wires.

8. The solid-state imaging apparatus of claim 7, further comprising an IR cut filter positioned between the solid-state imaging lens and the solid-state imaging chip, whereby the IR cut filter is below the solid-state imaging lens and above the solid-state imaging chip.

9. The solid-state imaging apparatus of claim 3, wherein the board is a flexible board having a cavity formed below the solid-state imaging lens, and the image signal processing semiconductor chip is adhered to the bottom surface of the solid-state imaging chip in the cavity.

10. The solid-state imaging apparatus of claim 9, wherein the image signal processing semiconductor chip is electrically connected to terminals formed on the bottom surface of the board by leads for tape automated bonding (TAB).

11. The solid-state imaging apparatus of claim 10, further comprising an IR cut filter positioned between the solid-state imaging lens and the solid-state imaging chip, whereby the infra red cut filter is below the solid-state imaging lens and above the solid-state imaging chip.

12. A solid-state imaging apparatus comprising:
a lens mounting portion to which a solid-state imaging lens is attached;
a solid-state imaging chip installed below the solid-state imaging lens, for converting light from the solid-state imaging lens into an image signal;
conductive lines formed at least on a lateral side of the solid-state imaging chip, the conductive lines for electrically connecting bonding pads formed on the top surface of the solid-state imaging chip to the terminals formed on the bottom surface of the solid-state imaging chip; and
a board fixed to the bottom surface of the lens mounting portion and electrically connected to the solid-state imaging chip by the conductive lines formed on the bottom surface of the solid-state imaging chip.

13. The solid-state imaging apparatus of claim 12, wherein the terminals formed on the bottom surface of the solid-state imaging chip are connected to metal wirings formed on the top surface of the board by solder balls or metal bumps.

14. The solid-state imaging apparatus of claim 13, further comprising an image signal processing semiconductor chip that is electrically connected to terminals formed on the bottom surface of the board.

15. The solid-state imaging apparatus of claim 14, wherein the image signal processing semiconductor chip is electrically connected to terminals formed on the bottom surface of the board by bonding wires.

16. The solid-state imaging apparatus of claim 14, wherein the image signal processing semiconductor chip is electrically connected to terminals formed on the bottom surface of the board by solder balls or metal bumps.

17. The solid-state imaging apparatus of claim 14, wherein the board has a cavity formed below the solid-state imaging lens, and the image signal processing semiconductor chip is adhered to the bottom surface of the solid-state imaging chip in the cavity.

18. The solid-state imaging apparatus of claim 17, wherein the image signal processing semiconductor chip is electrically connected to terminals formed on the bottom surface of the board by bonding wires.

19. The solid-state imaging apparatus of claim 18, further comprising an IR cut filter positioned between the solid-state imaging lens and the solid-state imaging chip, whereby the infra-red cut filter is below the solid-state imaging lens and above the solid-state imaging chip.

20. The solid-state imaging apparatus of claim 14, wherein the board is a flexible board having a cavity formed below the solid-state imaging lens, and the image signal processing semiconductor chip is adhered to the bottom surface of the solid-state imaging chip in the cavity.

21. The solid-state imaging apparatus of claim 20, wherein the image signal processing semiconductor chip is electrically connected to terminals formed on the bottom surface of the board by leads for TAB.

22. The solid-state imaging apparatus of claim 21, further comprising an IR cut filter positioned between the solid-state imaging lens and the solid-state imaging chip, whereby the infra-red cut filter is below the solid-state imaging lens and above the solid-state imaging chip.

23. A solid-state imaging apparatus comprising:
a solid-state imaging chip that converts light into an image signal, the solid-state imaging chip including first terminals on a top surface of the solid-state imaging chip and second terminals on a bottom surface of the solid-state imaging chip.

24. The solid-state imaging apparatus of claim 23, wherein, the solid-state imaging chip includes holes, the holes for electrically conductive material that electrically connects at least a portion of the first terminals to at least a portion of the second terminals.

25. The solid-state imaging apparatus of claim 24 further comprising:
a board electrically connected to the solid-state imaging chip by the second terminals.

26. The solid-state imaging apparatus of claim 25, further comprising:
an image signal processing semiconductor chip that is electrically connected to the board.

27. The solid-state imaging apparatus of claim 25, wherein the board has a cavity below the bottom surface of the solid-state imaging chip.

28. The solid-state imaging apparatus of claim 27, wherein the image signal processing semiconductor chip is below the cavity.

29. The solid-state imaging apparatus of claim 24, further comprising:
an image signal processing semiconductor chip that is attached to the bottom surface of the solid-state imaging chip.

30. The solid-state imaging apparatus of claim 29, further comprising:
a board with a cavity below the bottom surface of the solid-state imaging chip.

31. The solid-state imaging apparatus of claim 30, wherein at least a portion of the image signal processing semiconductor chip is within the cavity.

32. The solid-state imaging apparatus of claim 23, further comprising:
conductive material formed on lateral sides of the solid-state imaging chip that electrically connects at least a portion of the first terminals with at least a portion of the second terminals.

33. The solid-state imaging apparatus of claim 32 further comprising:
a board electrically connected to the solid-state imaging chip by the second terminals.

34. The solid-state imaging apparatus of claim 33, further comprising: an image signal processing semiconductor chip that is electrically connected to the board.

35. The solid-state imaging apparatus of claim 33, wherein the board has a cavity below the bottom surface of the solid-state imaging chip.

36. The solid-state imaging apparatus of claim 35, wherein the image signal processing semiconductor chip is below the cavity.

37. The solid-state imaging apparatus of claim 32, further comprising:
an image signal processing semiconductor chip that is attached to the bottom surface of the solid-state imaging chip.

38. The solid-state imaging apparatus of claim 37, further comprising:
a board with a cavity below the bottom surface of the solid-state imaging chip.

39. The solid-state imaging apparatus of claim 38, wherein at least a portion of the image signal processing semiconductor chip is within the cavity.

40. A solid-state imaging apparatus comprising:
a lens mounting portion to which a solid-state imaging lens is attached;
a solid-state imaging chip that converts light into an image signal, the solid-state imaging chip including first terminals on a top surface of the solid-state imaging chip and second terminals on a bottom surface of the solid-state imaging chip,
conductive material deposited in holes formed in scribe lines on the solid-state imaging chip, the conductive material for electrically connecting at least a portion of the first terminals to at least a portion of the second terminals; and
a board attached to the lens mounting portion and electrically connected to the solid-state imaging chip by the second terminals.

41. A solid-state imaging apparatus comprising:
a lens mounting portion to which a solid-state imaging lens is attached;
a solid-state imaging chip that converts light into an image signal, the solid-state imaging chip including first terminals on a top surface of the solid-state imaging chip and second terminals on a bottom surface of the solid-state imaging chip;
conductive lines for electrically connecting at least a portion of the first terminals to at least a portion of the second terminals; and
a board fixed to the bottom surface of the lens mounting portion and electrically connected to the solid-state imaging chip by the conductive lines formed on the bottom surface of the solid-state imaging chip.

42. A method of making a solid-state imaging apparatus comprising:
forming first terminals on a top surface of a solid-state imaging chip that converts light into an image signal; and
forming second terminals on a bottom surface of the solid-state imaging chip.

43. The method of claim 42, further comprising:
depositing electrically conductive material into holes of the solid-state imaging chip.

44. The method of claim 43, further comprising:
connecting at least a portion of the first terminals to at least a portion of the second terminals using the electrically conductive material.

45. The method of claim 42, further comprising:
forming electrically conductive material at least on a lateral side of the solid-state imaging chip.

46. The method of claim 45, further comprising:
connecting at least a portion of the first terminals with at least a portion of the second terminals using the electrically conductive material.

47. A method of making the solid-state imaging apparatus of claim 23 comprising:
forming the first terminals on the top surface of the solid-state imaging chip that converts light into an image signal; and
forming the second terminals on the bottom surface of the solid-state imaging chip.
